(19) United States
(12) Patent Application Publication
(10) Pub. No.: US 2006/0117295 A1
(43) Pub. Date: Jun. 1, 2006

(54) Automation platform for information management, condition monitoring and real time control of distributed industrial systems

(75) Inventors: Qing-Hua Wu, Liverpool (GB); David Peter Buse, Liverpool (GB); Pu Sun, Liverpool (GB)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: The University of Liverpool

(21) Appl. No.: 10/527,377

(22) PCT Filed: Sep. 9, 2003
(86) PCT No.: PCT/GB03/03918

§ 371 Date: Oct. 13, 2005

(30) Foreign Application Priority Data
Sep. 9, 2002 (GB) 0220899.9

(51) Int. Cl. G06F 9/44

(52) U.S. Cl. 717/104; 717/120

(57) ABSTRACT

The present invention provides a generic system architecture for use in forming automation systems comprising a plurality of software agents selectively adaptable to implement specific functions used for the integration of information management, condition monitoring and real-time control in an automation system for a distributed industrial system formed thereby. The invention also provides automation systems comprising a plurality of software agents adapted to implement specific functions used for information management, condition monitoring and real-time control in a coordinated manner.

The present invention relates to industrial automation systems and is concerned in particular with a system intended for integrated information management, condition monitoring and real-time control of distributed industrial systems using the Internet, computer network and software agent technologies.

Most industrial automation systems are based on the SCADA methodology, in which a central server monitors and controls a large number of devices. However, these systems provide limited flexibility, and often do not integrate well with other systems.

A conventional automation system used for control of an industrial plant consists of sensors connected to the plant, data acquisition devices, interface racks, actuators, cables and wires for transmission of analogue quantities, microprocessor-based controllers and a platform for operator intervention. The controllers, that are required to operate on-line in real-time, are usually connected to plant equipment through relatively short-length cables, wires or optical fibres, designed with consideration of signal distortion, noise interference and cable reliability. Therefore, the controllers are distributively installed within a limited distance in the plant and if there are large numbers of pieces of plant that undertake a variety of tasks within different time scales then the controllers are generally uncoordinated. For a complex industrial plant, such as a power system substation, chemical plant or steel manufacturer, it is difficult to connect various pieces of equipment, data acquisition devices, interface racks, actuators and controllers to central platforms and it would be extremely complex in practice to network these items horizontally and vertically within a hierarchic structure. The network would be very complex, as a huge number of cables and wires are used for a variety of purposes. Various items within the substation, such as control systems, protection systems, quality of supply monitors, condition monitoring equipment etc., collectively known as IEDs (intelligent electronic devices) would be networked together. There may be 50 IEDs of varying complexity at a large substation and there are 250 substations in England and Wales. Therefore, the task of developing and using such a complex and continually changing network is not at all straight forward. Due to the complexity of most industrial systems, the conventional automation system can only undertake simple tasks and it is not capable of providing the required information management, condition monitoring and real-time control functions simultaneously, and intelligent coordination between system devices.

In accordance with a first aspect of the present invention there is provided a generic system architecture for use in forming automation systems, the generic system comprising a plurality of software agents selectively adaptable to implement specific functions used for the integration of information management, condition monitoring and real-time control in an automation system for a distributed industrial system formed thereby.

In accordance with a second aspect of the present invention there is provided an automation system for a distributed industrial system, comprising a plurality of software agents adapted to implement specific functions used for information management, condition monitoring and real-time control in a co-ordinated manner.

Advantageously, these agents, and sometimes all of the agents in the system, can be controlled and managed by agent platforms and local directories.

An agent is a programable to perceive and react to changes in its environment It is capable of acting in an autonomous and goal-directed manner, so that the actions of an agent are not caused only by inputs from the environment, but by the goals or desires of the agent. This is in contrast to a standard computer program, whose actions are determined only by direct manipulation (e.g. clicking on icons) by users or commands from other programs. Therefore agent-based architectures can be much more flexible than standard architectures.

A plurality of different types of agent can be used, including Information Retrieval Agents, Database Agents, Device Agents and Plant Agents/Control Agents, supported by multi-agent technology and mobile agents.

Mobile agents may be used as an additional communications mechanism between the user agent and information providing agents (“information providing agent” refers to any agent providing information, for example the plant agents and database agents).

A mobile agent is a program able to transport itself from one place to another and continue its execution. This means that the mobile agents can run small programs of their own directly on a target location. By using mobile agents, the information recovered can be geared directly to the type of user, displaying only the relevant information in the format most suited to the user type. Hence different types of mobile agents will normally be used. These mobile agents could have the ability of being active. The use of multi-agent technology can greatly enhance development of distributed databases, designed in association with various tasks implemented in WAN and different LANs, respectively.

Advantageously, the architecture of the present system makes use of standard, currently available technology, including the FIPA standards for agent platforms. All current publicly available FIPA platforms are based on Java. The control agents and user interface agents are intended to be resident on devices and to perform real-time tasks. In this case, Java is not a preferred choice for implementation of these agents due to its memory and processor requirements. The user interface agent must integrate with existing HMI and user interface packages. For this task, Active X controls are often a suitable option.

Preferably, the system has an open standard architecture and clearly defined protocols and interfaces, adapted to allow integration of a variety of software and hardware.

Preferably, at least some of the system components can be re-configured dynamically.

Preferably, the system includes comprehensive HMIs and a web browser and provides real-time operator intervention.

Preferably, the system allows connections of mobile servers.

Preferably, the system is adapted to embed user applications of information management, condition monitoring and real-time control flexibility.

Advantageously, the system is arranged to posses the potential of adding intelligent behaviour using different agent models and embedding intelligent approaches to plant operation and control problems.

Advantageously, the system is adapted to provide an integration of information management, condition monitoring and real-time control functions for various devices distributed over LANs and WAN.

Preferably, the system is adapted to be able to handle different types of tasks in different time scales required for the information management, condition monitoring and real-time control of large-scale distributed industrial systems.

Advantageously, the system has potential to be applied for small and large industrial systems.

Advantageously, the system is adapted to enable the use of commercial real-time application platforms, such as Lookout, Automation X and RTAP, etc, as HMIs.

Systems in accordance with the invention can be built out of many local and small components with greater flexibility.

Thus, in contrast to conventional automation systems, a system in accordance with the present invention (usually referred to by us as an e—Automation system) can provide integrated functionalities for distributed information management, intelligent monitoring and real-time control with an open architecture of IP networks for implementation of various tasks within Wide Area Networks (WAN), Local Area Networks (LAN) and wireless LANs. RGE system will be able to provide great gridability and communication capability to resolve the problems of task implementation and information management for a wide range of distributed industrial systems such as power plant, power utility, railways, manufacture and chemical plants, and medical care etc., using network and multi-agent technologies, with intelligence embedded in the system network and software structures.

A system in accordance with the present invention can be designed to implement various tasks such as Data acquisition, Data transportation, Database updating, Knowledge base updating, Information management, Information retrieval, Network computing, Dynamic display, Real-time control and Operator intervention, etc. These tasks may have a different nature and are conducted at different time scales over WAN and LAN. The implementation of these tasks requires support of various protocols, which may be developed using different software languages and standards such as C, Java, XML, TCP/IP, CORBA, RDF, SQL, Active X etc. The protocols development work is undertaken according to the IEC, FIPA and IEEE standards.

Further advantages which can be acquired by systems in accordance with the invention include:
a) system can be built out of many small components—giving greater flexibility;
b) system capable of dynamic re-configuration—components can be added and removed while the system is running;
c) the system is distributed—information and control is local rather than central;
d) loose coupling between components—adds robustness;
e) can be open system—standard, clearly defined protocols and interfaces allow integration of a variety of software and hardware; and
f) it is possible to add intelligent behaviour using different agent models.

This invention thus introduces a concept of e-Automation, which defines a new generation of automation systems for information management condition monitoring and real-time control of a wide range of distributed industrial systems, with the integration of the latest network and agent technologies. It provides an open architecture with software intelligence and system coordination embedded for the design and development of large-scale distributed industrial automation systems.

At a first level, various agents are introduced to provide an integrated approach to the information management, condition monitoring and real-time control of industrial systems.

At a second level, an open architecture of the system is designed specifically for development of various distributed industrial automation systems.

At a third level, an agent platform and a local directory system are employed to control and manage multiple tasks, including the multiple agents, online in real-time.

At a fourth level, the interfaces and protocols conversions between different agents, Human-Machine interfaces, data sockets, databases and IEDs are developed, according to the designed architecture and the IEC, FIPA and IEEE standards, to enable the integration of all functions provided by the e-Automation system. This development is represented by computer code.

The invention is described further hereinafter, by way of example only, with reference to the accompanying drawings, in which:

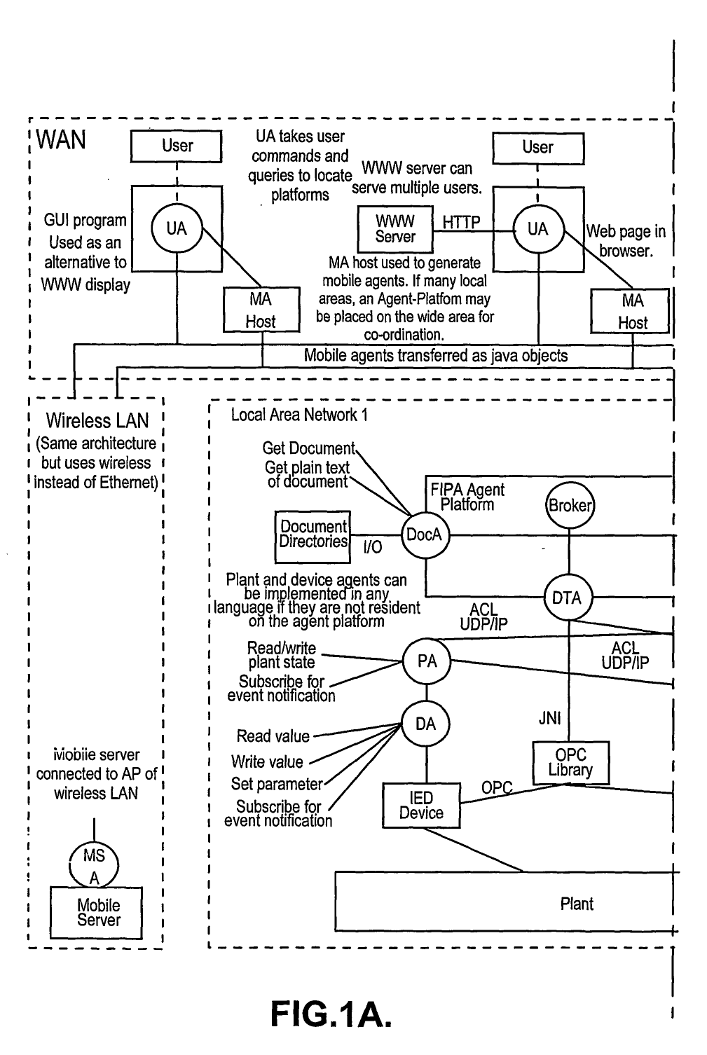

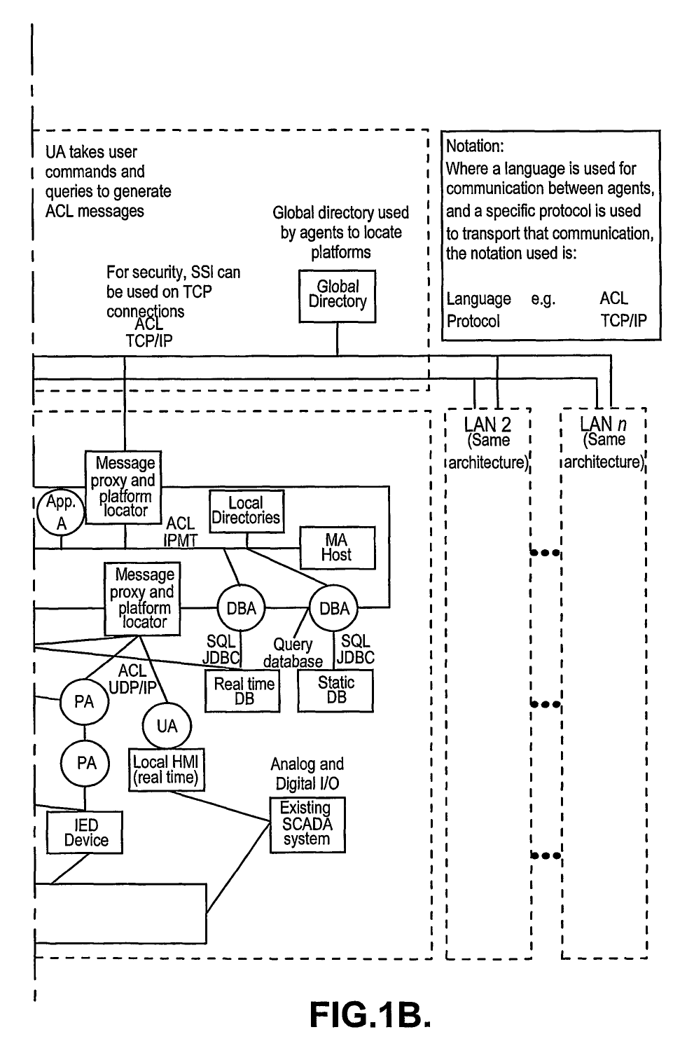

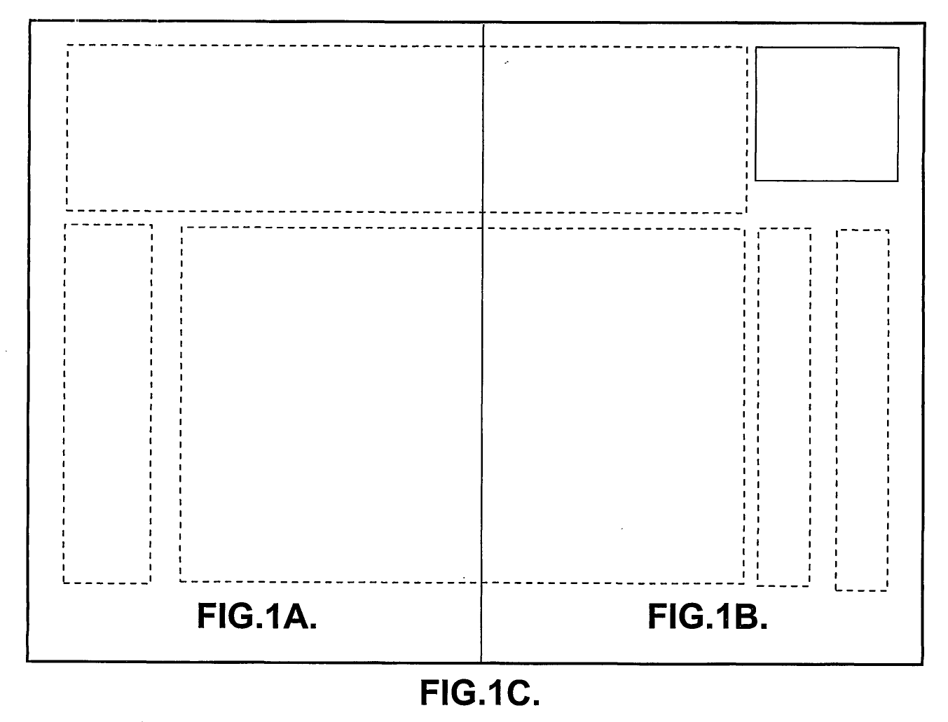

FIG. 1 is a diagrammatic illustration of the architecture of one possible embodiment in accordance with the present invention;

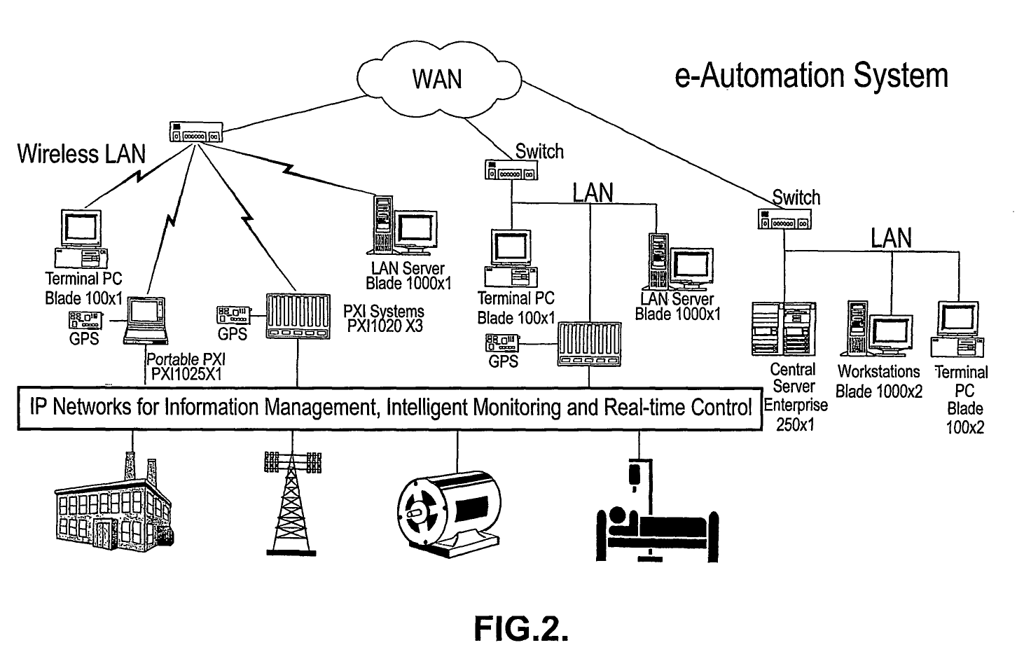

FIG. 2 illustrates the architecture of an automation system embodying the invention;

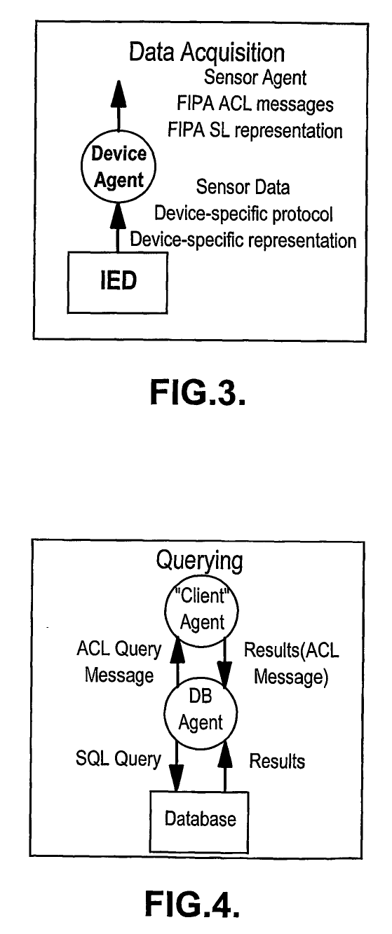

FIGS. 3 to 12 are function diagrams illustrating details of the system of FIG. 1;

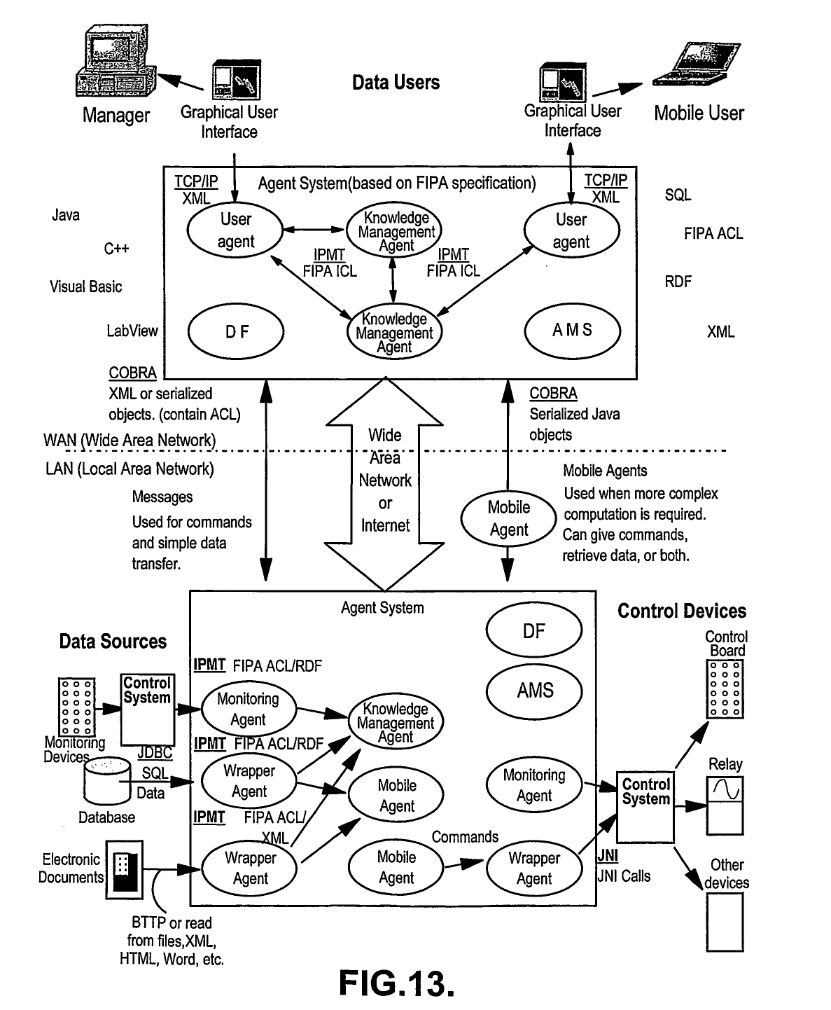

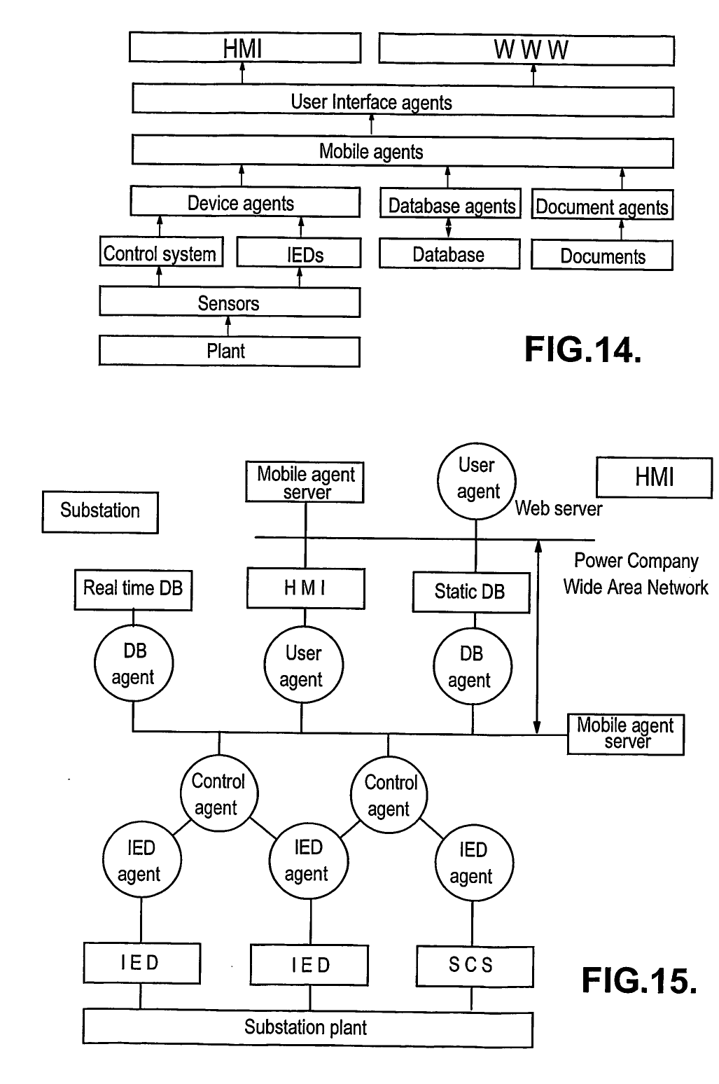

FIGS. 13 and 14 illustrate a further embodiment of system architecture in accordance with the invention; and

FIG. 15 illustrates a specific application of the architecture of FIGS. 13 and 14.

FIG. 1 illustrates the software architecture used to form one possible embodiment of an automation system embodying the present invention. For an understanding of the architecture of the system of FIG. 1 having WAN, LANs and wireless LANs, reference is directed to the following list of possible system components, some or all of which may be present in any particular embodiment depending upon the practical application to which the system of invention has been applied:
AP: Agent platform, A server or set of servers on which agents can execute. The AP provides messaging and directory facilities for the agents.
A CL: FIPA Agent Communication Language. A standard language used for communication between software agents.
App. A: Application Agent. These agents perform tasks such as knowledge management, alarm/event handling etc., depending on the needs of particular locations or applications.
CA: Control (device) Agent. This agent controls a device.
DB: Database.
DBA: Database Agent. This agent allows others to query the real-time database.
DocA: Document Agent. This agent provides access to a document collection.
DTA: Data Transport Agent. This agent acquires data from the IEDs and stores it into the real-time database. This is an additional functionality to the database agent, which allows only database queries. This task is not performed by the control agents in order to reduce the load on these agents. If data transport functionality is provided by the IEDs, SCADA or HMI system, this agent is not required. The DTA may either be resident on the agent platform or outside (on the diagram it is shown inside the AP).
OntoDB: Ontology Database used to store the vocabularies which are related to applications.
OA: Ontology Agent. This agent is used to update and manage the ontology database.
FIPA: Foundation for intelligent Physical Agents. A standards organisation for multi-agent systems.
GUI: Graphical User Interface.
HMI: Human-Machine Interface.
HTTP: Hypertext Transfer Protocol. The protocol used for transmitting Web pages.
IED: Intelligent Electronic Device. A control or monitoring device containing an embedded processor
IP: Internet used for network packet delivery on the Internet. IP is normally used in combination with TCP or UDP.
IPMT: Internal Platform Message Transport. An acronym used by FIPA to denote whatever transport protocol is used for message transport within a FIPA platform. Many FIPA platforms use Java RMI as the IPMT.
JDBC: Java Database Connectivity.
LAN, WAN: Local Area Network, Wide Area Network.
Local directories. The local directories are used to assist agents in locating each other. Agents that provide a service register with a directory. Client agents (the user agent, mobile agents and possibly other agents) can then use the directory to locate services that match their requirements. The DF (Directory Facilitator) is a standard component of a FIPA agent platform, and provides such a directory service.
DF: Directory Facilitator.
MA, MA Host mobile Agent, Mobile Agent Host.
Mobile Server: A server that is temporarily added to the system in order to provide some specific functionality, for example, the detailed monitoring of an item plant.
MSA: Mobile Server Agent. Either a database agent or control agent (some mobile servers may have both of these) responsible for providing access to the resource of a mobile server.
MTP: Message Transport Protocol. There are a number of message transport protocols that may be used for inter-platform communications, e.g., IIOP, HTTP.
Message Proxy and Platform Locations translates from a non-standard format, such as ACL over TCP/IP, to a standard format used by an agent platform. It is also possible to build in service location features to allow agents to locate the nearest platform within a local area network.
OPC: OLE for Process Control.
SCADA: Supervisory Control and Data Acquisition system. Used for control and monitoring of many industrial systems.
SL: Semantic Language (FIPA SL). A standard language defined by FIPA to represent the content of an ACL message.
SQL: Structured Query Language. A standard language for performing database queries.
SSL: Secure Sockets Layer. A protocol used on the Internet for encryption of online transactions. Based on public key cryptography.

TCP: Transport Control Protocol. A connection-oriented network protocol which provides reliable message delivery.
UA: User Agent.
UDP: User Datagram Protocol. A connectionless network protocol that is faster, but less reliable, than TCP.
WWW: World Wide Web.

Some agents shown in FIG. 1 are outside the AP. The idea behind the architecture is to make use of standard, currently available technology, including the FIPA standards for agent platforms. All current publicly available FIPA platforms are based on Java. Therefore, agents implemented using other languages such as C++ can not run on these platforms'servers.

Problems with this are encountered in relation to the control agents and user interface agents. The control agents are intended to be resident on devices and to perform real-time tasks. Therefore, Java is currently a poor choice for implementation of these agents due to its memory and processor requirements. The user interface agent must integrate with existing HMI and user interface packages. For this task, Active X controls are often a suitable option, but these cannot be implemented using standard Java.

The simplest way to integrate agents written in different languages and on a variety of systems is to use a soclcets-based protocol (TCP or UDP). However, because there is no publicly available FIPA platform that supports such a protocol, a gateway is used to translate message between this protocol and the Java objects used to transfer ACL messages within the FIPA platform. The agents outside the AP are able to communicate with those agents managed by the AP.

The agents shown in FIG. 1 cooperate according to the following description.

Data from the plant is gathered by some control or monitoring system (not part of the e-automation system). A device agent or agents responsible for this device then acquires the data using a device-specific method (the details of which are not covered by this system) and converts it to a representation consisting of a channel identifier and a data value. An example of a device-specific method might be the use of a device driver and software libraries to implement regular polling of the input channels of the device. The channel identifier and data value are to be communicated to other agents in a FIPA SL (Semantic Language) statement or other acceptable FIPA content language, and using a defined ontology.
Plant agents are assigned to specific items of plant. These agents acquire data from the appropriate device agents using either the FIPA query protocol (for one-off queries) or the FIPA subscribe protocol (in which the plant agent is notified each time the value of a channel or channels changes). In each case, the plant agent contains a mapping database consisting of rules specifying the correspondence between plant properties (e.g. the low voltage current of a transformer in a power system) and the values of input channels on a data acquisition device. The plant agent can locate appropriate device agents using the local directory, in which device agents register the channels for which they are responsible. When information is obtained from the plant agent, it is converted to a plant state representation using the mapping rules.

Agents may query the plant agents using the FIPA query protocol to obtain information, or may subscribe for notification of plant state changes using the FIPA subscribe protocol. To request changes to the state of the plant, the FIPA request protocol is used.

The user interface agent integrates an HMI developed using a standard software platform such as LabVIEW with the multi-agent system. The user interface agent performs the following functions:
1. Querying of historical data, using the FIPA query protocol.
2. Regular update of the HMI with new data and events as they occur. This is carried our using the FIPA subscribe protocol to register with plant agents or other information providing agents in order to be notified when the values displayed in the HMI change.
3. Carrying out control actions as requested by the user. This uses the FIPA request protocol.

Communications with the HMI may use any protocol or method compatible with the HMI platform. For example, a LabVIEW HMI might use the National Instruments DataSocket technology.

FIG. 2 is a diagrammatic illustration of a possible hardware embodiment of an automation system having some of the software components as shown in FIG. 1. It shows a system involving three local area networks (LANs) responsive to I P networks for information management, intelligent monitoring and real-time control of a plurality of industrial systems, such as factories, power stations, and hospitals, and integrated by a single wide area network (WAN).

FIGS. 3 to 12 describe how various tasks may be performed by agents contained within an automation system in accordance with the invention, and show the data transferred between agents. The tasks described in FIGS. 3 to 12 are the basic tasks of an e-autornation system, and include, among others, data acquisition, database and document querying and user interaction. Each task is implemented by a subset of the agents in the fully automation system.

Data Acquisition (FIG. 3) is performed by the device agent, which converts sensor data into an ACL and SL representation of a channel value.

Database querying (FIG. 4) is performed by the client agent (which is usually a user interface agent, however, other agents may also need to access the databases to retrieve configuration information) and the database agent.

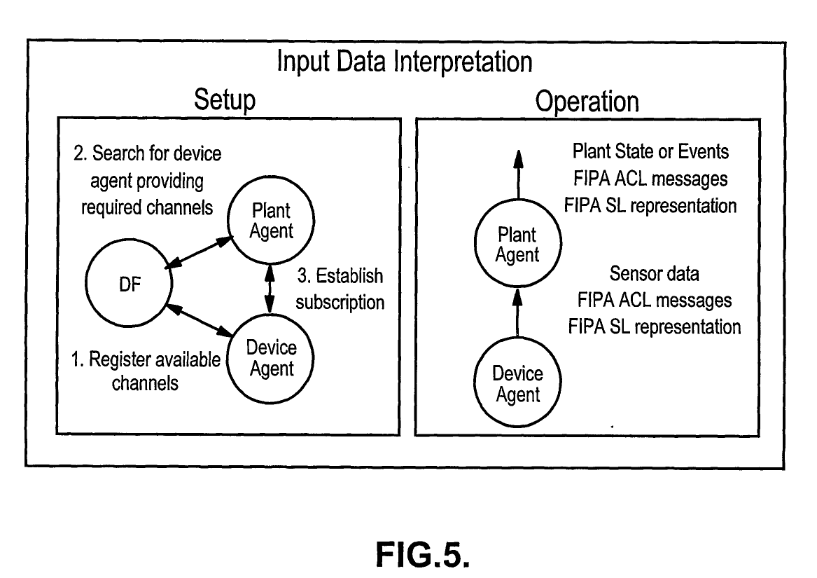

Input Data Interpretation (FIG. 5) transforms channel/value pairs into a representation of the plant state, and is performed by the plant agent, as described hereinbefore.

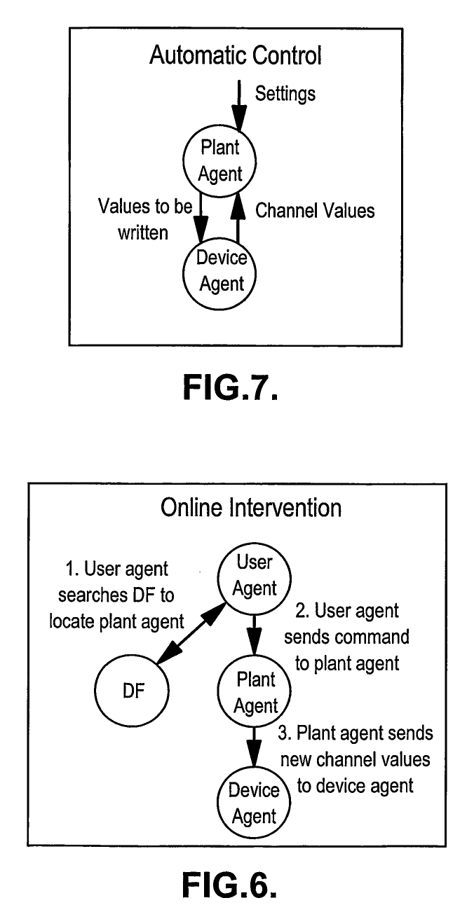

Online Intervention (FIG. 6) is carried out by the user interface agent in cooperation with the plant agents. To determine the appropriate plant agent to carry out a task, the directory service of the agent platform is used.

Automatic Control (FIG. 7) is the responsibility of the plant agent.

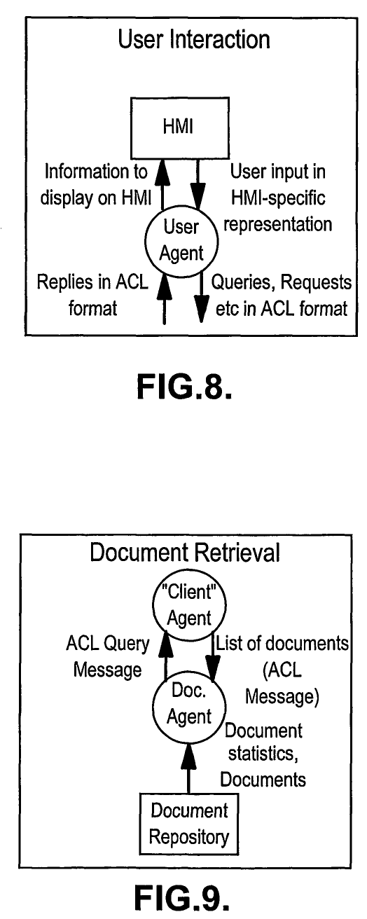

User Interaction (FIG. 8) covers the various tasks performed by the user interface agent.

Document retrieval (FIG. 9) is a function of the document agent. A client agent (normally a user agent) sends the document agent a query consisting of a set of keywords. The document agent will then return a list of documents relevant to that query, using some available information retrieval algorithm. The client agent may then retrieve the full text of documents from the document agent.

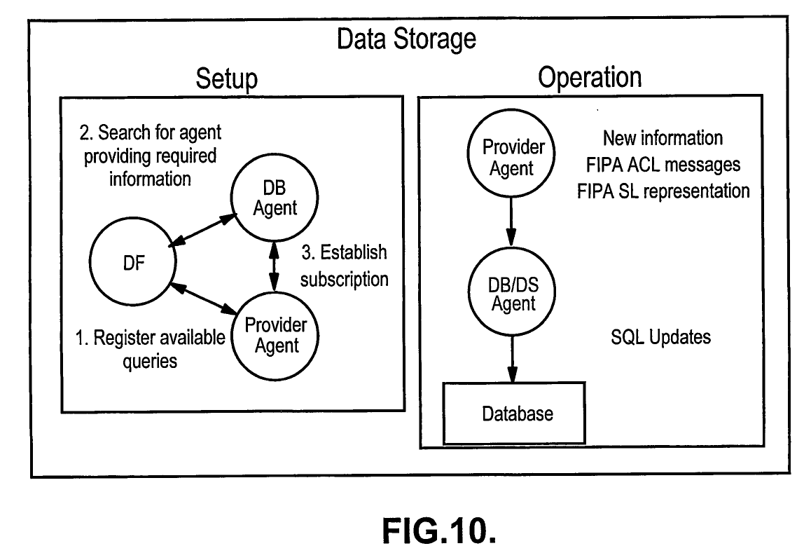

Data storage (FIG. 10) is carried out by a data storage agent (not shown in FIG. 1).

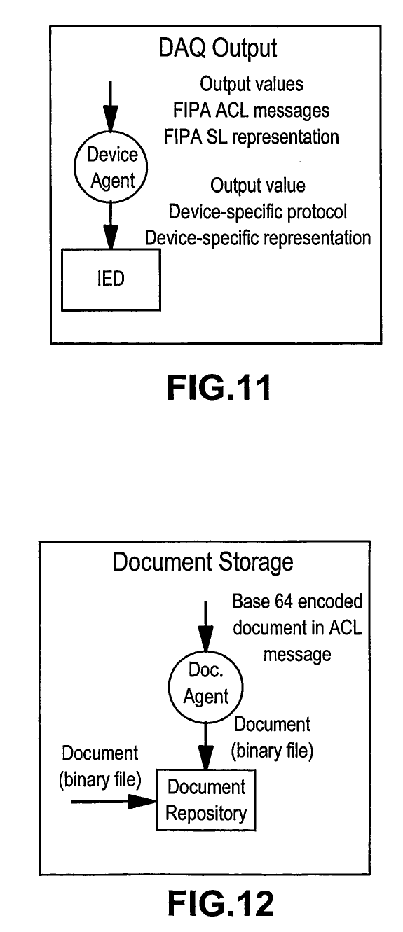

DAQ Output (FIG. 11) involves the transmission of analogue or digital values via the output channels of a control device. This is performed by the device agent, on receipt of requests from other agents.

Document Storage (FIG. 12) may be performed by the document agent or by a separate document storage agent, and involves the transmission of documents to the agent, which then stores them in a document repository for later access. The document agent is responsible for generating document statistics for all documents in its repository.

An example implementation of an e-automation system is for information management and remote control of a power system substation. A substation contains various items of plant including transformers, switchgear (disconnectors, circuit breakers) and control and monitoring equipment. An e-automation system for installation in a substation has a device agent for each control or monitoring device (referred to as an Intelligent Electronic Device or IED). These agents may be installed either on the IED itself if it is capable of hosting such agents, or on a server or servers located in the substation. Plant agents are then used to represent the transformers and switchgear.

The substation contains several databases, including a static database to store configuration and topology information, a database to store monitoring information and a database to store the system ontology (or data model). Each of these databases is represented by a database agent.

To store data into the substation databases, a data storage agent may be used. The implementation of this agent specifies using a FIPA SL expression for any data that must be stored in the database. When executed, the data storage agent will locate agents providing this data using the platform's directory facilities, and will execute the specified query, retrieving the data, which will then be stored in the database using mapping rules provided in the agent's implementation.

An HMI platform, managed by a user interface agent, is included. The user may perform the tasks of historical data querying, online monitoring, document retrieval and intervention. These tasks are implemented as described hereinbefore.

Reference is now made to FIGS. 13, 14 and 15 which give further details of systems in accordance with the present invention and describe further specific embodiments by way of example.

The software architecture shown in FIG. 13 is split into two main components, the LAN and WAN segments, which are connected by communication between agents and by the movement of mobile agents from one agent platform to another. The LAN component contains many server agents, including database agents, device agents, control agents and brokers. It is also possible for some server agents, such as database or document agents, to be in the WAN component. Most agents in the WAN component are user agents, which act as the user interface to the system. There are also a number of mobile agents, each performing a different task such as information retrieval or data analysis on behalf of the user agents.

To allow agents to locate each other and to publish the services that they offer, a number of “system agents” are included in the architecture. The agent management system (AMS) and directory facilitator (DF), specified by the Foundation for Intelligent Physical Agents (FIPA), are respectively responsible for managing agent execution, and for maintaining a searchable list of services offered by agents.

A broker allows clients to use agent services without having to know which agents they are provided by. Clients can send requests to the broker, which selects an appropriate service provider agent to carry out the request.

FIG. 14 shows how information in the system is transferred from plant, database and documentation to users via the multi-agent system. Information is gathered from the plant either by IEDs or by a control system. Device agents and control agents attached to these systems are then responsible for providing the information to other systems. Additional information is provided by database agents and document agents, and the database agent may also be responsible for storing information gathered by the device agents in a database. The information provided by all of these agents is gathered by mobile agents, acting on behalf of user interface agents, which are responsible for providing the information to users.

Device agents: These agents are responsible for a specific monitoring or control device, such as a protection relay or data acquisition system. They provide two main services to other agents: a device independent means for control agents to read and write to the input and output channels of the device; it is also responsible for managing the device configuration, and for allowing users (via the user agents) to alter this configuration if necessary.

Control agents: A control agent (or plant agent) is responsible for the monitoring and control of a particular item of substation plant. For example, in a power system a control agent might be responsible for a transformer or circuit breaker. Control agents sense and act on the plant via device agents.

If an implementation of the system was not to be used for control, but only for monitoring purposes, the control agents could still be used, but would only fulfil the task of collecting information regarding the item of plant and providing this information to other agents. In certain applications, the control agents might be subject to real-time constraints, which would affect their implementation.

Database agents: These agents are responsible for managing access to a database. In order to permit other agents to query the database using ACL, the database agents must be capable both of translating from the ACL language to SQL, the language used for database access, and of translating from the data model used by the agents to the database scheme.

Document agents: These agent manage a set of documents stored on a server and allow other agents to retrieve them using FIPA agent communication language (ACL) requests. They may also provide information to agents regarding the contents of these documents, to allow agents to select documents relevant to a particular query.

User agents: User agents provide a user interface to the system that allows its implementation details to be hidden from the user. There are a number of different ways in which the user agent can be displayed. For example, the user agent may be integrated into an HMI package or shown on a web page. There are also a number of different implementation methodologies for interface agents, which provide varying degrees of intelligence. In order that the user agent is able to provide a personalised service to the user, it must maintain a profile containing information about the user's interests and typical information requirements. This allows it to select information that is most appropriate to the user.

Mobile information agents: Mobile agents are appropriate either to improve the performance of an application by reducing the amount of data that must be transmitted over a slow network connection, or to enhance the flexibility of a service by allowing it to be customised to a particular application or user.

The mobile data analysis agent can consist of a number of components, for example, the agent body can firstly contain code common to all analysis agents, such as the abilities to move and locate service agents. Secondly, a number of analysis functions provide subroutines for use in data analysis. Thirdly a configuration file specifies the analysis functions required by a particular agent, the source of the data to be analysed and several other configuration parameters. This file can also include a report template, written in HTML and using special tags to include results produced by analysis functions. This allows the agent to generate a report in the form of a web page.

The document retrieval agent takes as its input a set of query terms describing the documents that must be retrieved. It then travels between sites collecting relevant documents, before passing them to the user.

Mobile remote control agents: Mobile remote control agents can be used to initiate a series of control actions on an item or items of plant. The agent is dispatched from the operator's location to the location of the plant, and will then carry out the specified actions by interacting with the control agents. This means that interactions with the plant can take place over a network with low latency and high bandwidth.

Agents communicate in a peer-to-peer manner—any agent is able to communicate with any other agent. Agents can also use directory and broker services to locate other agents offering services in which they are interested. Agent communication uses the FIPA ACL. This is a high-level language, which allows for a wide range of possible interactions.

In certain circumstances, it might be decided that a high-level ACL is too inefficient to meet real-time constraints. In this case, a set of agents could communicate with each other using another mechanism. A “gateway” agent could then be used to translate between the communication format and language used by these agents and that used by the rest of the system.

In practice, the architecture described here can be applied, for example, to power substation information management. Power systems produce a large quantity of information. For example, the National Grid Company operates a network of around 150 substations in England and Wales. Each of these substations contains around 50 IEDs which perform control and monitoring of the plant, which includes transformers, switchgear etc. These IEDs and other control and monitoring equipment generate a very large quantity of data.

The use of the current multi-agent architecture in this context is illustrated in FIG. 15. As can be seen, each IED is allocated an IED agent, based on the generic device agent described hereinbefore. Control agents are then used to manage the data from IEDs and pass it to other agents for display and storage. The substation contains both a real-time database, used for logging events, alarms and condition monitoring data, and a static database, which holds information about the substation topology. Both these databases are managed by database agents. HMI platforms, managed by user interface agents, are provided both in the substation and on the wide area network. A web-based interface is also provided.

Thus, the proposals herein described provide a basis for the creation of a variety of applications in a modular fashion and explain how to define the flow of data between these applications and the method in which they may be integrated.

The present invention thus enables the provision of a platform and architecture which can be built upon to create many different applications. This is achieved by applying agent technology to manage the flow of data in an automation system, to provide a mechanism for the integration of different tasks and to enhance the flexibility of the system. The tasks described, achievable by the system are generic so as to be applicable in a wide range of contexts.

1. A generic system architecture for use in forming automation systems, the generic system comprising a plurality of software agents selectively adaptable to implement specific functions used for the integration of information management, condition monitoring and real-time control in an automation system for a distributed industrial system formed thereby.

2. An architectural system as claimed in claim 1, which comprises a plurality of different types of software agents.

3-17. (canceled)

18. An architectural system as claimed in claim 2, which contains an ontology agent used to update and manage an ontology database.

19. An architectural system as claimed in claim 2, wherein at least some of the agents in the system are controlled and managed by agent platforms and local directories.

20. An architecture system as claimed in claim 2, wherein said different types of agent include any of Information Retrieval Agents and Database Agents, and any of Device Agents and Plant Agents/Control Agents.

21. An architectural system as claimed in claim 1, which includes one or more mobile agents.

22. An architectural system as claimed in claim 21, in which said mobile agent or agents each provide an additional communications mechanism between a user agent and one or more information providing agents.

23. An architectural system as claimed in claim 1 that has an open standard architecture and defined protocols and interfaces, allowing integration of a variety of software and hardware.

24. An architectural system as claimed in claim 1, having system components which can be reconfigured dynamically.

25. A architectural system as claimed in claim 1 that has comprehensive HMIs and Web browser and provides real-time operator intervention.

26. An architectural system as claimed in claim 1 that allows connections of mobile servers.

27. An architectural system as claimed in claim 1, adapted to embed user applications of information management, condition monitoring and real-time control flexibly.

28. An architectural system as claimed in claim 1, adapted to enable the adding of intelligent behaviour using different agent models.

29. An architectural system as claimed in claim 1, adapted to provide an integration of information management, condition monitoring and real-time control functions for various devices distributed over LANs and WAN.

30. An architectural system as claimed in claim 1, adapted to handle different types of tasks in different time scales required for the information management, condition monitoring and real-time control of large scale distributed industrial systems.

31. An architectural system as claimed in claim 1, adapted to enable the use of commercial real-time application platforms as HMIs.

32. An automation system formed using a generic architectural system as claimed in claim 1.

33. An automation system for a distributed industrial system, comprising a plurality of software agents adapted to implement specific functions used for information management, condition monitoring and real-time control in a co-ordinated manner.
